(19) United States
(12) Patent Application Publication
(10) Pub. No.: US 2011/0068186 A1
(43) Pub. Date: Mar. 24, 2011

(54) Broadcast\widecast pattern lawn watering implement

(76) Inventors: Carylon Deneice Kent, Aurora, IL (US); Lamar Steven Henry, Aurora, IL (US)

(21) Appl. No.: 12/586,377

(22) Filed: Sep. 22, 2009

(51) Int. Cl. B05B 9/01

(52) U.S. Cl. 239/1; 239/525

(57) ABSTRACT

A handheld, lightweight method of transferring the water column from a standard garden hose into a time saving and water saving broadcast and/or spray pattern.

### FIELD OF THE INVENTION

The present invention relates to and describes a method of transforming a water column from a standard garden water hose into a wide-cast and/or broadcast spray pattern. Specifically, the invention relates to facilitating the transformation of a standard water column from a standard garden water hose into a wide-cast and/or broadcast spray pattern by way of an implement that is handheld and lightweight.

### BACKGROUND

Current lawn watering methods involve either a handheld narrow water stream or a wide-cast/broadcast ground-located or ground anchored sprinkler. Ways to bridge the gap between hand-held and ground anchored/based functionality is hence desirable, so that one single user interface would suit both types of functionality properly.

### SUMMARY OF THE INVENTION

An object of the invention is to overcome at least some of the drawbacks relating to the restrictions with respect to current devices as discussed above. Hence, in a first aspect there is provided a method for producing a wide spray pattern using a handheld, lightweight device, which is fed by a standard garden water hose. In other words, the handheld device is configured in such a way that it generates a wide-cast spray pattern that saves both time and uses less water when compared to traditional watering methods. In summary, a user interface style is achieved that provides the user with increased flexibility and efficiency with respect to covering more ground more thoroughly while using the same amount of water when compared to a traditional handheld hose end sprayer.

### BRIEF DESCRIPTION OF DRAWINGS

Having thus described the invention in general terms, reference will now be made to the accompanying drawings, which are not necessarily drawn to scale, and wherein:

FIG. 1 shows a two-dimensional view of the spraying implement in two pieces in a flat plate view.

### DETAILED DESCRIPTION OF DRAWINGS

The present invention will now be described, after with reference to the accompanying drawing, in which an example of an embodiment of the invention is shown. Indeed, the invention may be embodied in many different forms and should not be construed as limited to the embodiment set forth herein; rather, this embodiment is provided by way of example so that this disclosure satisfies applicable legal requirements. Like numbers refer to like elements throughout.

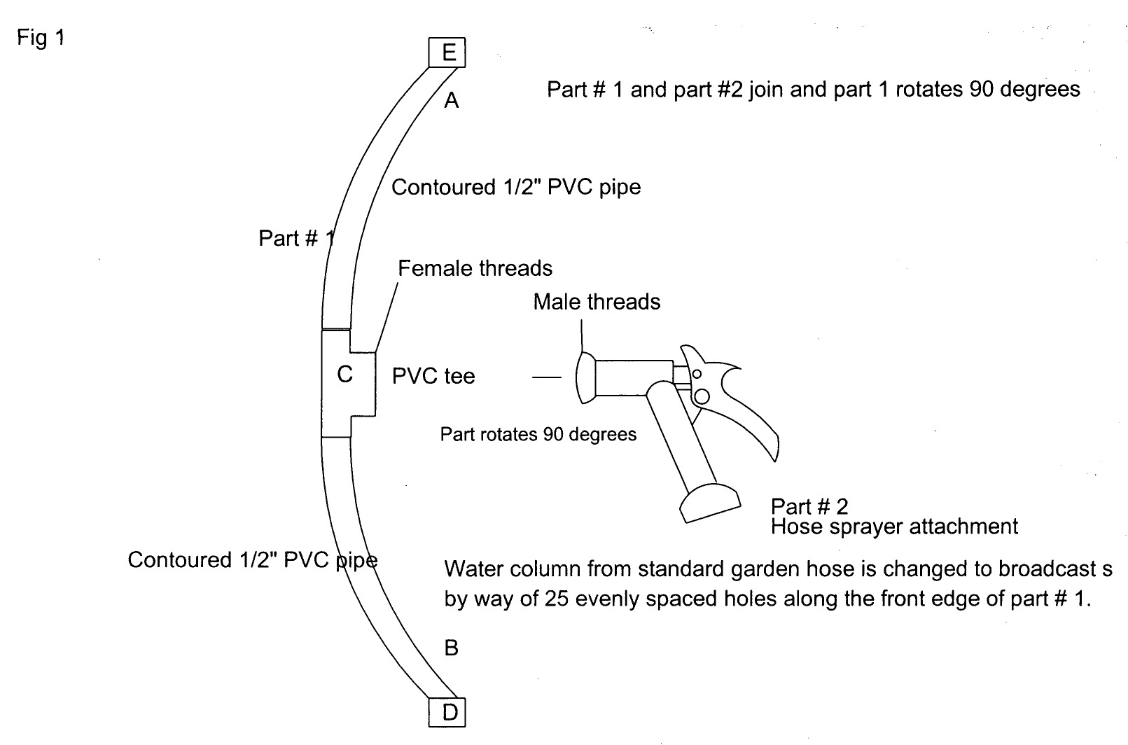

FIG. 1 shows the watering implement/device in a flat plate view broken in two pieces for clarity and ease of explanation.

Part #1 consists of two contoured ½ inch PVC tubes and one ½ inch PVC tee section and two ½ inch end caps. The parts outlined in the previous sentence are assembled in such a way that the two contoured tubes are affixed to the tee and terminate with the end caps as shown, this assembly forms a plenum that holds incoming water under pressure while it is expelled through 25 evenly spaced (0.0625 inch= 1/16 inch) holes on the front edge of part #1.

1. A handheld, lightweight device and method of transferring a standard water column from a standard garden hose into a wide-cast and broadcast spray pattern

2. The method and device in claim 1 will cover and covers and/or encompasses any and all possible permutations and interpretations of the basic idea of transferring a standard water column from a standard garden water hose into a wide-cast and/or broadcast spray pattern by way of handheld implement and/or device, this includes and encompasses any and all possible construction methods including any one-piece or multi-piece interpretations manufactured or designed with respect to and relating to the fundamental idea set forth in claim 1.
